(19) United States
(12) Patent Application Publication
(10) Pub. No.: US 2015/0097660 A1
(43) Pub. Date: Apr. 9, 2015

(54) BLIND VIEW SENSOR ASSEMBLY

(71) Applicant: JOEL ADELL, PASADENA, CA (US)

(72) Inventor: JOEL ADELL, PASADENA, CA (US)

(21) Appl. No.: 14/050,253

(22) Filed: Oct. 9, 2013

(51) Int. Cl. B60R 1/08; G08B 5/36; G08B 3/10

(52) U.S. Cl. CPC B60R 1/081; G08B 3/10; G08B 5/36; B60R 2300/802; B60R 2300/8093
USPC 340/435

(57) ABSTRACT

A blind view sensor assembly for notifying a driver whenever an object is in the blind spot of the driver's vehicle comprises an assembly base attached to the conventional side view mirror of a automobile. The assembly base attaches to the bottom of the side view mirror and utilizes an optical sensor to detect objects which enter or are otherwise present in the blind spot on the side of the vehicle it is disposed, an LED light to visually signal when a vehicle is detected in the blind spot, and a speaker to audibly sign when a vehicle is detected in the blind spot. Each assembly base installed on a vehicle automatically configures itself for the side of the vehicle on which it is mounted each time it is started. It then provides a audible and visual notification when an object is in the blind spot of the vehicle.

### BACKGROUND OF THE INVENTION

1. Field of the Invention

This invention relates generally to automotive accessories and, more particularly, to a blind spot sensor assembly which alerts a driver of objects in the blind spot of the blind spot of vehicle.

2. Description of the Prior Art

It is believed that the number of automobiles in the world has doubled in the last 20 to 30 years, and now exceeds 1 billion. As motorists all tend to share the same roadways, one obvious consequence of such growth is that the roadways are becoming more crowded. As roadways become more crowded, it stands to reason that more caution must be used than ever to avoid accidents and drive safely.

The use of optical aids, such as side view mirrors and a rear view mirror, to improve driver visibility vehicles is well known. Despite their use, it is well established that with some vehicles, such as cars, trucks, motorboats, sail boats and aircraft, that blind spots still exist. As the very existence of such blind spots is a threat to safe road traffic, the problem imposed by blind spots in land vehicles such as cars and trucks is embodied as an ongoing threat to the safety of every occupant of such vehicles on the road. Thus, there remains a need for an assembly which can mitigate the threat of blind spots in vehicles by advising a driver when other vehicles are present in the vehicle's blind spot. It would be helpful if such a blind view sensor assembly utilized visible and audible alerting signals to apprise the driver of objects in her vehicle's blind spot. It would be additionally desirable for such a blind view sensor assembly be integrated with the turning signals on a vehicle. It would even further be desired is such a blind view sensor assembly was able to be manufactured on new cars or installed on existing cars.

The Applicant's invention described herein provides for a sensor assembly adapted to provide visual and/or audible alerts to a motorist when an object is in the motorists blind spot. The primary components of Applicant's blind view sensor assembly are a housing, an optical sensor, and an alert signal. When in operation, the blind view sensor assembly allows a motorist to be notified of the presence of objects in the blind spot of the vehicle being driven. As a result, many of the limitations imposed by optical aids in many vehicles are removed.

### SUMMARY OF THE INVENTION

A blind view sensor assembly for notifying a driver whenever an object, such as another vehicle, is in the blind spot of the driver's vehicle. The blind view sensor assembly comprises an assembly base attached to the conventional side view mirror of a land vehicle such as a car or truck. The assembly base attaches to the bottom of the side view mirror and utilizes an optical sensor to detect objects which enter or are otherwise present in the blind spot on the side of the vehicle it is disposed, an LED light to visually signal when a vehicle is detected in the blind spot, and a speaker to audibly sign when a vehicle is detected in the blind spot. The assembly base is configured to be powered by an internal batter, but can also be connected to, and operate using, electrical power from the vehicle on which it is mounted. The assembly base can also be connected to the turn signal connectors in the vehicle for enhanced operations

Each assembly base installed on a vehicle automatically configures itself for the side of the vehicle on which it is mounted each time it is started. Whenever a moving object enters into blind area of the vehicle being monitored, it causes the speaker to emit an alert beep sound and the LED light to illuminate. Such alerts progressively increase as an object remains in the blind area or if the driver actuates his turn signal.

It is an object of this invention to provide an blind view sensor assembly which can mitigate the threat of blind spots in vehicles by advising a driver when other vehicles are present in the vehicle's blind spot.

It is another object of this invention to provide a blind view sensor assembly which utilizes visible and audible alerting signals to apprise the driver of objects in her vehicle's blind spot.

It is yet another object of this invention to provide a blind view sensor assembly which is integrated with the turning signals on a vehicle.

It is still another object of this invention to provide a blind view sensor assembly which was able to be manufactured on new cars or installed on existing cars.

These and other objects will be apparent to one of skill in the art.

### BRIEF DESCRIPTION OF THE DRAWINGS

FIG. 1 is a front elevational view of a blind view sensor assembly built in accordance with the present invention attached to the passenger-side side view mirror of a vehicle.

FIG. 2 is a front elevational view of a blind view sensor assembly built in accordance with the present invention disconnected from any side view mirror.

### DETAILED DESCRIPTION OF THE INVENTION

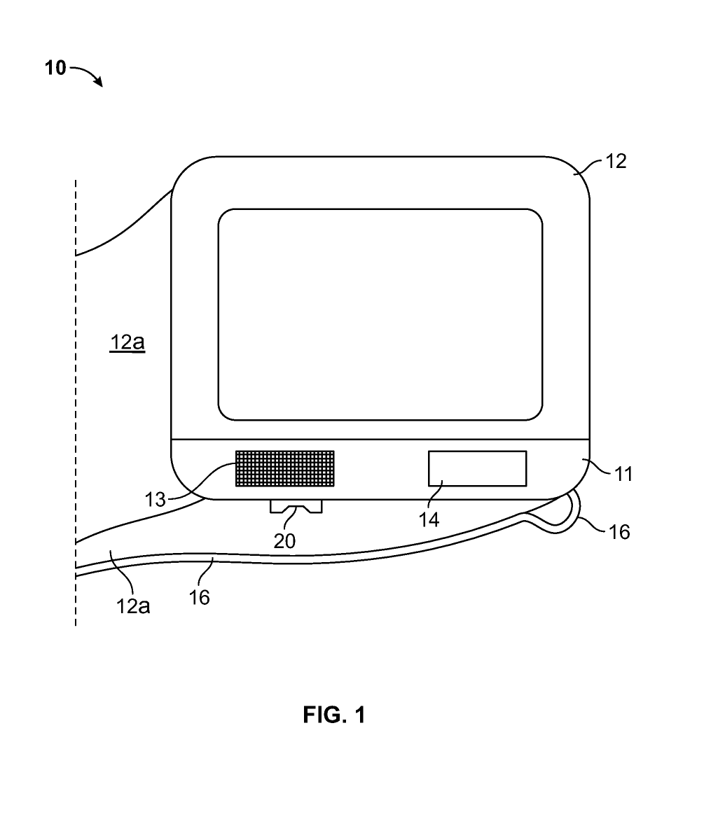

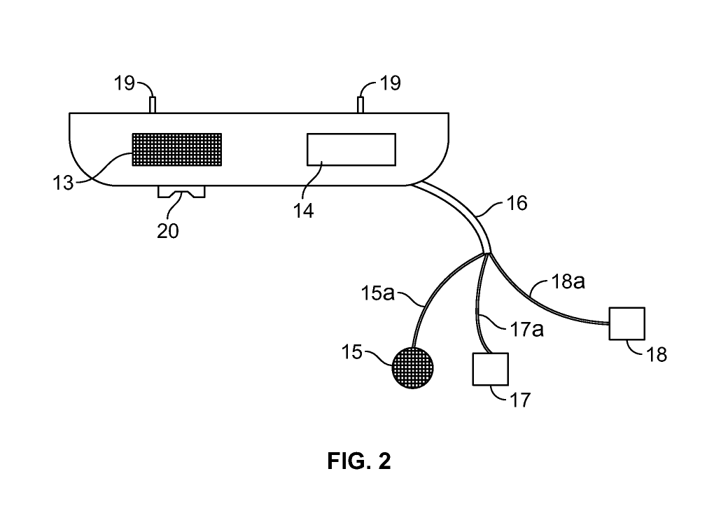

Referring now to the drawings and in particular FIGS. 1 and 2, a blind view sensor assembly 10 is defined by an assembly base 11 which is attached to a conventional side view mirror 12. The assembly base 11 attached to the bottom of the side view mirror 12, whether it is disposed on the driver side or the passenger side, and utilizes an optical sensor 13 to continually check for and detect objects which enter or are otherwise present in the blind spot on the side of the vehicle it is disposed. Once an object is detected, a visual alert from an LED light 14 disposed on the assembly base 11 is provided in the form of illumination in either yellow or red. In addition, an audible alert is provided through a speaker 15, which when the assembly base 11 is installed on the side view mirror of a vehicle, is located inside the subject vehicle and electrically connected to the assembly base through a speaker wire 15a carried by a cable 16. The cable 16, which is installed to run from the assembly base 11 along the arm 12a of the side view mirror and into the subject vehicle, carries in the preferred embodiment not just the speaker wire 15a, but also an power wire 17a to allow for an optional power connector 17 to connect to the subject vehicle's electrical power system and a signal wire 18a to allow for an optional turn signal connector 18 to connect to the turn signal of the subject vehicle.

The assembly base 11 includes an internal battery (not shown) for supplying electrical power to the sensor 13, the LED light 14, and the speaker 15. In an embodiment wherein the assembly base 11 is connected to the subject vehicle's electrical power system, the internal battery provides backup power so as to allow the assembly base 11 to operate even if the connection to the subject vehicle's power system is lost. Whether the power source for the assembly base 11 is the internal battery or the subject vehicle's power system, a power toggle switch 20 is provided to allow the assembly base 11 to be turned on and off by a user as desired. In installations of the assembly base 11 wherein it is not connected to the power system of the subject vehicle, the power toggle switch 20 allows for the conservation of the electrical power stored in the internal battery. Even in installations wherein the assembly base 11 is connected to the power system of the subject vehicle, the power toggle switch 20 allows for a user to selectively power off the assembly base 11 as desired so as to reduce strain on the electrical components of the subject vehicle, including without limitation a battery or an alternator.

In the preferred embodiment, the assembly base 11 is attached to the side view mirror 12 of a subject vehicle through the use of two screws 19. In alternate embodiments, an adhesive fastener (not shown) is used to attach the assembly base 11 to a side view mirror.

In operation, each assembly base 11 installed on a vehicle is configured for the side of the vehicle on which it is mounted. The configuration process occurs each time the assembly base is turns on, wherein it first identifies the arm 12a, then the side surface of the car to set itself to target the area adjacent to the side of the car opposite the arm 12a. The sensor 13 continually monitors the target area the and when a moving object enters into the target area, it sends a signal to an internal controller (not shown) which indicates the same. The controller then causes the speaker to emit an alert beep sound and the LED light to blink yellow. If a detected object remains in the target area, the sensor signals the controller to emit a louder alert sound, more frequently, from the speaker and to cause the LED light to blink red. If the turn signal connector 18 is operational, the controller is notified whenever the turn signal in the vehicle is on and any signal from the sensor indicating an object is in the target area to the controller, while the turn signal is on, will result in causes the loudest, most frequent alert sound to emit from the speaker and the LED light to blink red.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An blind view sensor assembly comprising:
an assembly base configured to be mounted to the side view mirror of a vehicle, wherein said assembly base includes an internal power source connecter to a controller and a sensor and at least one sensory alert device connected to said controller;
wherein said sensor is configured to monitor an area proximal to a vehicle on which the assembly base in mounted and provide an alert electrical signal to said controller whenever an object enters the area monitored;
wherein said sensory alert device is defined by a capability to produce an sensory signal, defined as an audibly or visually perceptible signal, in response to controller activity; and
wherein said controller is adapted to cause the at least one sensory alert device to provide an a sensory signal whenever it receives said alert electrical signal from said sensor.

2. The blind view sensor assembly of claim 1, wherein the sensor is an optical sensor.

3. The blind view sensor assembly of claim 1, wherein the sensor is configured to provide at least two distinct alert electrical signals in response to the movement of objects in the area monitored.

4. The blind view sensor assembly of claim 3, wherein a speaker is provided as the at least one sensory alert device and the sensory signal is a beep.

5. The blind view sensor assembly of claim 4, wherein the controller, in response to distinct alert signals, is configured to cause the speaker to beep at least two distinct intervals.

6. The blind view sensor assembly of claim 3, wherein a LED light is provided as the at least one sensory alert device and the sensory signal is a flash of light.

7. The blind view sensor assembly of claim 6, wherein the controller, in response to distinct alert signals, is configured to cause the LED light to flash in at least two distinct colors.

8. The blind view sensor assembly of claim 3, wherein a speaker and a LED light are provided as the sensory alert devices.

9. The blind view sensor assembly of claim 8, wherein the controller, in response to distinct alert signals, is configured to cause the speaker to beep at least two distinct intervals and to cause the LED light to flash in at least two distinct colors.

10. The blind view sensor assembly of claim 3, wherein the controller is electrically connected to the power system of the vehicle on which the assembly base is mounted.

11. The blind view sensor assembly of claim 3, wherein the controller is configured to receive turn electrical signals defined as signals indicating the actuation of a turn signal from the vehicle on which the assembly base is mounted.
